(19) United States
(12) Patent Application Publication
(10) Pub. No.: US 2025/0262873 A1
(43) Pub. Date: Aug. 21, 2025

(54) LIQUID DISCHARGE APPARATUS

(71) Applicant: Norikazu YANASE, Kanagawa (JP)

(72) Inventor: Norikazu YANASE, Kanagawa (JP)

(21) Appl. No.: 19/056,791

(22) Filed: Feb. 19, 2025

(30) Foreign Application Priority Data
Feb. 20, 2024 (JP) 2024-023685

(51) Int. Cl. B41J 11/42; B41J 2/21; B41J 11/00; B41J 25/00

(52) U.S. Cl. CPC B41J 11/42; B41J 2/2103; B41J 2/2117; B41J 11/007; B41J 25/001

(57) ABSTRACT

A liquid discharge apparatus includes a first head to discharge a first ink; a second head to discharge a second ink different from the first ink; a carriage mounting the first head and the second head to move the first head and the second head in a first scanning direction; a conveyor to move a medium relative to the carriage in a second scanning direction orthogonal to the first scanning direction; and circuitry. The circuitry causes the conveyor to move the medium at least with a first acceleration or at a first speed when the first head discharges the first ink; and causes the conveyor to move the medium at least with a second acceleration different from the first acceleration or at a second speed different from the first speed when the second head discharges the second ink.

### CROSS-REFERENCE TO RELATED APPLICATIONS

This patent application is based on and claims priority pursuant to 35 U.S.C. § 119(a) to Japanese Patent Application No. 2024-023685, filed on Feb. 20, 2024, in the Japan Patent Office, the entire disclosure of which is hereby incorporated by reference herein.

### BACKGROUND

### Technical Field

The present disclosure relates to a liquid discharge apparatus.

### Related Art

A liquid discharge apparatus is known that conveys a liquid application object in the sub-scanning direction to a position opposing the carriage, using a conveyance member. Afterward, the carriage, equipped with a liquid discharge head, reciprocates in the main scanning direction, allowing the liquid discharge head to discharge liquid onto each position of the liquid application object, forming an image.

As an example of the above-described liquid discharge apparatus, multiple platens of different sizes are selectively used. In this liquid discharge apparatus, the conveyance speed of the platen is changed according to its size.

Such a liquid discharge apparatus needs to move the conveyance member at a higher speed to form images on the liquid application object, thus increasing its productivity.

### SUMMARY

An embodiment of the present disclosure provides a liquid discharge apparatus includes a first head to discharge a first ink; a second head to discharge a second ink different from the first ink; a carriage mounting the first head and the second head to move the first head and the second head in a first scanning direction; a conveyor to move a medium relative to the carriage in a second scanning direction orthogonal to the first scanning direction; and circuitry. The circuitry causes the conveyor to move the medium at least with a first acceleration or at a first speed when the first head discharges the first ink; and causes the conveyor to move the medium at least with a second acceleration different from the first acceleration or at a second speed different from the first speed when the second head discharges the second ink.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a liquid discharge apparatus;

FIG. 2 is a diagram of an abnormal image;

FIG. 3 is a flowchart of a printing process;

FIG. 4A is a timing chart of pre-treatment printing and a white printing operation, illustrating the speed transition of a stage during a printing operation;

FIG. 4B is a timing chart of a color printing operation, illustrating the speed transition of the stage during a printing operation;

FIGS. 5A, 5B, 5C, 5D, 5E, and 5F are graphs presenting maximum speeds and accelerations in pre-treatment printing, white printing, and color printing; and

FIG. 6 is a block diagram of a hardware configuration of a controller.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

By increasing the moving speed of the conveying member, the productivity of the apparatus can be enhanced. However, vibrations occur due to the rapid acceleration or deceleration of the conveyance member. The occurrence of vibrations causes the carriage equipped with a liquid discharge head to vibrate, potentially resulting in image defects such as vertical unevenness on the liquid application object.

According to one aspect of the present disclosure, the vibration of the carriage can be reduced or prevented.

Referring to the drawings, embodiments of the present disclosure are described below. In the drawings, the same or corresponding parts are denoted by the same reference numerals, and redundant descriptions are simplified or omitted as appropriate. In the following description, a liquid discharge apparatus that discharges liquid onto fabric as the liquid application object is described as a liquid discharge apparatus according to one or more embodiments of the present disclosure.

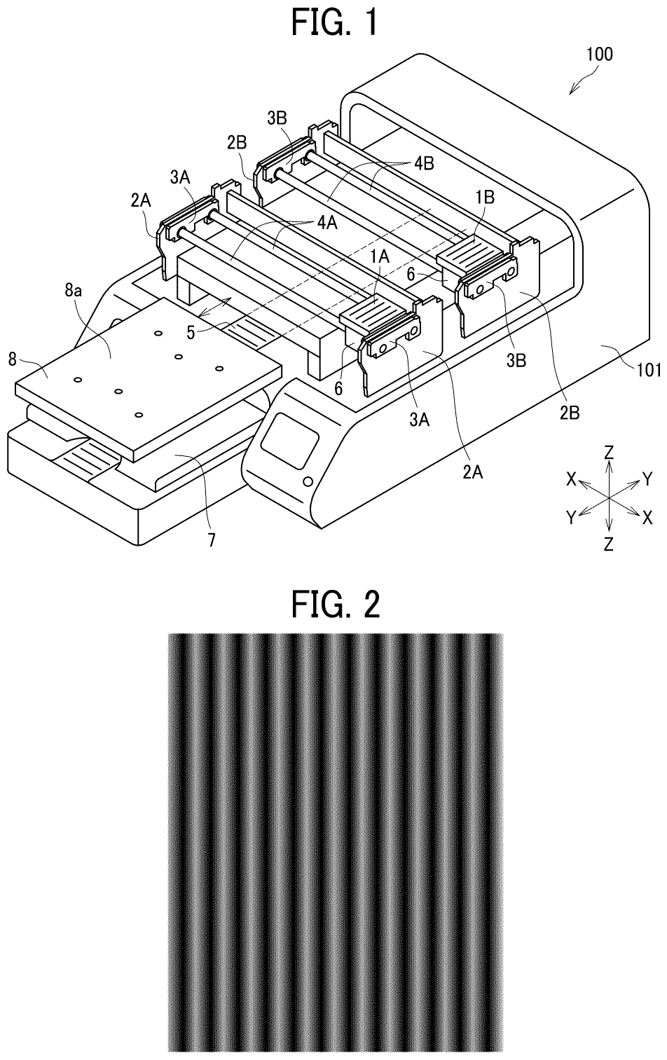

FIG. 1 is a perspective view of a liquid discharge apparatus 100. An X direction illustrated in FIG. 1 is a main scanning direction or a left-right direction of the liquid discharge apparatus 100. A Y direction is a conveyance direction of a fabric, a movement direction of a stage, or a front-to-back direction of the liquid discharge apparatus 100. The fabric is an example of a printing object or a liquid application object or a medium. The stage is an example of a platen. The stage moves back and forth, and the fabric is conveyed back and forth. A Z direction is an up-to-down direction of the liquid discharge apparatus 100 and is a direction perpendicular to an arrangement surface of the liquid application object (fabric) of the stage. The X, Y, and Z directions are orthogonal to each other. However, these directions may not be orthogonal to each other.

As illustrated in FIG. 1, the liquid discharge apparatus 100 includes a first carriage 1A and a second carriage 1B, a pair of first side plates 2A, a pair of second side plates 2B, first adjustment plates 3A as a pair of first holders, second adjustment plates 3B as a pair of second holders, first guide rods 4A as a pair of first guides, and second guide rods 4B as a pair of second guides. Note that the first carriage 1A and the second carriage 1B are also collectively referred to as the carriages 1 or referred to as the carriage 1 unless distinguished. The first side plates 2A and the second side plates 2B are also collectively referred to as side plates 2 or referred to as a side plate 2 unless distinguished. The first adjustment plates 3A and the second adjustment plates 3B are also collectively referred to as adjustment plates 3 or referred to as an adjustment plate 3 unless distinguished. The first guide rods 4 and the second guide rods 4B are also collectively referred to as guide rods 4 or referred to as a guide rod 4 unless distinguished.

The side plates 2 are disposed on both sides in the left-right direction of the liquid discharge apparatus 100 and are fixed to a body 101 of the liquid discharge apparatus 100. The side plate 2 movably holds the adjustment plate 3 in the Y direction and the Z direction.

Both ends of the guide rod 4 are respectively held by the adjustment plates 3. Each adjustment plate 3 carries two guide rods 4 in the Y direction.

The carriage 1 is movably supported on a guide rod 4 so that the carriage is movable along the guide rod 4. The carriage 1 includes multiple liquid discharge heads 6. The liquid discharge head 6 has a nozzle face on a lower surface thereof.

The liquid discharge apparatus 100 includes a rail 5 extending in the Y direction on the body 101. A stage 7 as a conveyance member or a conveyor is placed on the rail 5. A platen 8 is held on the stage 7. The platen 8 holds a fabric as a printing material or a liquid application object.

Specifically, the fabric is placed on the placement surface 8a of the platen 8. The placement surface 8a serves as a surface for placing the liquid application object. The placement surface 8a is a surface perpendicular to the Z direction. However, the placement surface 51a does not have to be strictly perpendicular to the Z direction.

The stage 7 is placed on the rail 5 so that the stage 7 reciprocate on the rail 5. The reciprocating movement of the stage 7 conveys the fabric on the platen 8 in the sub-scanning direction, enabling liquid to be discharged onto the fabric. In other words, the stage 7 moves the fabric to a position facing the carriage 1, and the liquid discharge head 6 of the carriage 1 discharges ink onto the fabric while the carriage 1 reciprocates in the X direction on the guide rod 4. Thus, an image is formed on the fabric. The platen 8 can be moved in the Z direction relative to the stage 7 to adjust the height of the placement surface 8a of the platen 8.

The liquid discharge apparatus 100 includes the multiple carriages 1 so that the liquid discharge apparatus 100 can discharge inks of different colors onto the fabric 900 and increase a printing speed on the fabric 900 to improve the productivity of the liquid discharge apparatus 100.

During the image formation operation on the fabric by the liquid discharge head 6, liquid is discharged onto a designated row in the sub-scanning direction of the fabric as the carriage 1 reciprocates. Once the discharge is complete, the stage 7 moves in the sub-scanning direction to position the next row of the fabric at the liquid discharge position of the liquid discharge head 6. Then, with the stage 7 stopped, the carriage 1 similarly reciprocates to discharge liquid onto the next row of the fabric on the stage 7. By repeating this, the liquid can be discharged onto the entire image forming portion of the fabric.

However, the intermittent movement of the stage 7 in the sub-scanning direction, involving acceleration and deceleration, results in vibrations of the stage 7. The carriage 1 also vibrates when the vibration is transmitted from the body 101 to the guide rods 4. Then, the carriage 1 vibrates during the liquid discharge operation, causing abnormal images such as periodic unevenness in the main scanning direction as illustrated in FIG. 2. The periodic unevenness is, for example, vertical stripes extending in the sub-scanning direction. FIG. 2 presents a periodic uneven image with vertical stripes that appear when a solid image is formed.

In contrast, by reducing the acceleration of the stage 7 or by allowing time to elapse after the movement of the stage 7, the vibration of the carriage 1 is minimized or prevented, thus reducing or preventing the formation of the abnormal image. However, this configuration leads to an increase in printing time.

In the following description, a printing process according to one or more embodiments is described. Further, a configuration that prevents the formation of abnormal images due to the vibration of the carriages 1 is described.

The liquid discharge apparatus according to the present embodiment can perform three types of printing: color printing (or a first liquid discharge operation to discharge a color ink as a first ink using a first head), white printing (or a second liquid discharge operation to discharge a white ink as a second ink using a second head), and pre-treatment printing (or a third liquid discharge operation to discharge a third ink using a third head). As an example, white printing and color printing are performed by the liquid discharge head on the first carriage 1A of FIG. 1. In color printing, inks of cyan, magenta, yellow, and black are discharged. However, the combination is not limited to this; any combination may be used as long as an image of a desired color can be formed. Alternatively, monochrome printing using only black ink may also be performed. In other words, the color printing refers to a printing operation of forming an image on fabric, which is a liquid application object. The white printing is a process of printing a white background portion on the surface of the fabric before the color printing is performed. The liquid discharge head on the second carriage 1B in FIG. 1 performs pre-treatment printing by discharging the pre-treatment liquid. The pre-treatment printing is a printing operation distinct from white printing and color printing, the latter being a printing operation for forming an image. The pre-treatment printing is performed prior to both white printing and color printing. However, the type of the other printing operations is not limited to this.

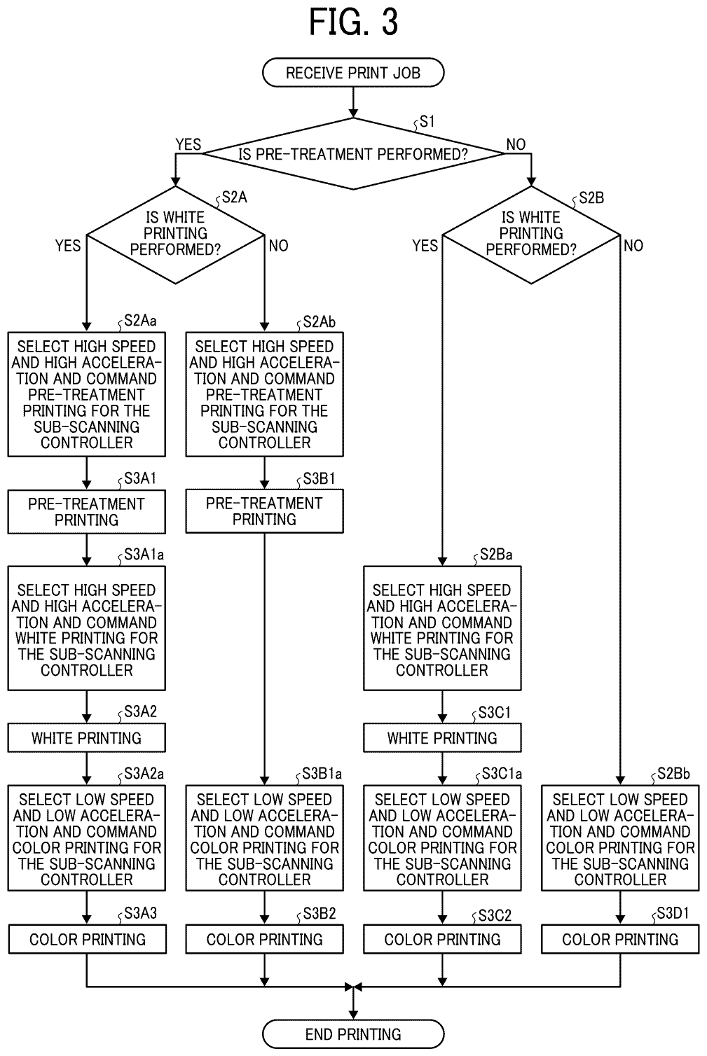

FIG. 3 is a flowchart of a printing process.

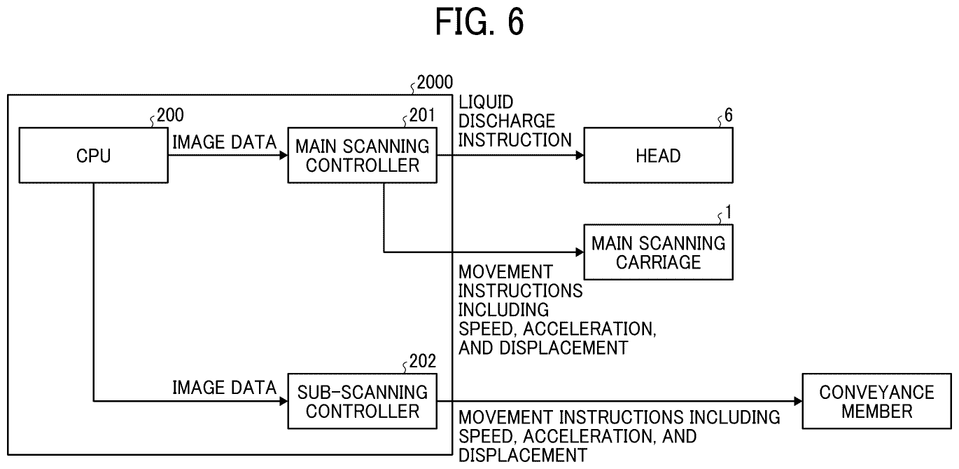

As illustrated in FIG. 3, in response to receiving a print job, a controller 2000 (in FIG. 6) of the liquid discharge apparatus determines whether the pre-treatment printing is to be performed in step S1 and determines whether the white printing is to be performed in steps S2A and S2B. Thus, four kinds of printing operations are performed. More specifically, four kinds of printing operations include: all of the three types of printing operations are performed (steps S3A1 to S3A3); pre-treatment printing and color printing are performed (S3B1 and S3B2); white printing and color printing are performed (S3C1 and S3C2); and only color printing is performed (S3D1).

After receiving the print job, the controller 2000 determines whether pre-treatment printing is to be performed (step S1) and also whether white printing is to be performed (step S2A or S2B). When determining that pre-treatment printing is to be performed (YES in step S1) and white printing is to be performed (YES in step S2A), the CPU 200 selects high speed and high acceleration and commands the sub-scanning controller 202 to perform pre-treatment printing (step S2Aa). The sub-scanning controller 202 executes pre-treatment printing at high speed and high acceleration (step S3A1).

Subsequently, the controller 2000 (i.e., the CPU 200) selects high speed and high acceleration and commands the sub-scanning controller 202 to perform white printing (step S3A1a). The sub-scanning controller 202 executes white printing at high speed and high acceleration (step S3A2).

The CPU 200 controls the sub-scanning controller to perform color printing (step S3A3) at low speed and low acceleration, which are lower than those of pre-treatment printing and white printing (step S3A2a).

When determining that pre-treatment printing is to be performed (YES in step S1) and white printing is not to be performed (NO in step S2A), the CPU 200 selects high speed and high acceleration and commands the sub-scanning controller 202 to perform pre-treatment printing (step S2Ab). The sub-scanning controller 202 executes pre-treatment printing at high speed and high acceleration (step S3B1).

Subsequently, the CPU 200 selects low speed and low acceleration and commands the sub-scanning controller 202 to perform color printing (step S3B1a), and controls the sub-scanning controller to perform color printing at low speed and low acceleration (step S3B2).

When determining that pre-treatment printing is not to be performed (NO in step S1) and white printing is to be performed (YES in step S2B), the CPU 200 selects high speed and high acceleration and commands the sub-scanning controller to perform white printing (step S2Ba). The sub-scanning controller 202 executes white printing at high speed and high acceleration (step S3C1).

Subsequently, the CPU 200 selects low speed and low acceleration and commands the sub-scanning controller 202 to perform color printing (S3C1a). The CPU 200 controls the sub-scanning controller 202 to perform color printing at low speed and low acceleration (step S3C2).

When determining that pre-treatment printing is not to be performed (NO in step S1) and white printing is not to be performed (NO in step S2B), the CPU 200 selects low speed and low acceleration and commands the sub-scanning controller to perform color printing (step S2Bb). The CPU 200 controls the sub-scanning controller 202 to perform color printing at low speed and low acceleration (step S3D1).

The low speed and low acceleration, as well as the high speed and high acceleration, may be predefined standard values. The control may also involve selecting speed and acceleration from the predefined low speed and low acceleration or high speed and high acceleration in accordance with the flowchart.

Additionally, the memory unit of the CPU or other components may store the speed and acceleration for each operation. By storing this information, the speed and acceleration can be adjusted according to the printing conditions.

From the perspective of white printing quality, it is preferable that the speed or acceleration of white printing is lower than or equal to that of pre-treatment printing.

From the perspective of color printing quality, it is preferable that the speed or acceleration of color printing is lower than or equal to that of pre-treatment printing and white printing.

From the perspective of overall print quality, it is more preferable that the speed and acceleration decrease in the order of pre-treatment printing, white printing, and color printing.

Note that the term “high speed and high acceleration” may also refer to “high speed and low acceleration” or “low speed and high acceleration”.

In the present embodiment, the stage 7 is reciprocated once back and forth for one printing operation. In other words, the liquid discharge operation is performed by either the first carriage 1A or the second carriage 1B by one reciprocating movement of the stage 7. However, different printing operations may be performed by discharging liquid from each carriage during one reciprocating movement. Further, the white printing may be performed multiple times (for example, twice) by reciprocating the stage 7 multiple times.

In the liquid discharge apparatus of the present embodiment, the acceleration and the speed of the stage 7 (or the platen 8) in the color printing for forming an image are set to be lower than the acceleration and the speed of the stage 7 (or the platen 8) in the white printing and the preprocessing printing operation (other printing operations). However, the speed or acceleration of the color printing (or a printing operation for forming an image) may be set to be lower than the acceleration or speed of any of the white printing and the pre-treatment printing (or other printing operations).

In operations other than those for forming images on fabric, such as white printing or pre-treatment printing, even if abnormal images like those illustrated in FIG. 2 are formed, such abnormal images are less likely to be visually recognized as defective images. On the other hand, in color printing, which involves forming images on fabric, abnormal image formation is more likely to be visually recognized as a defective image. Thus, by setting the speed or acceleration of the color printing (or a printing operation for forming an image) lower than that of other printing operations, as in this embodiment, it is possible to minimize the vibration of the stage 7 during the color printing while keeping the overall printing time as short as possible. In other words, both the productivity of the liquid discharge apparatus and the prevention of abnormal images can be achieved.

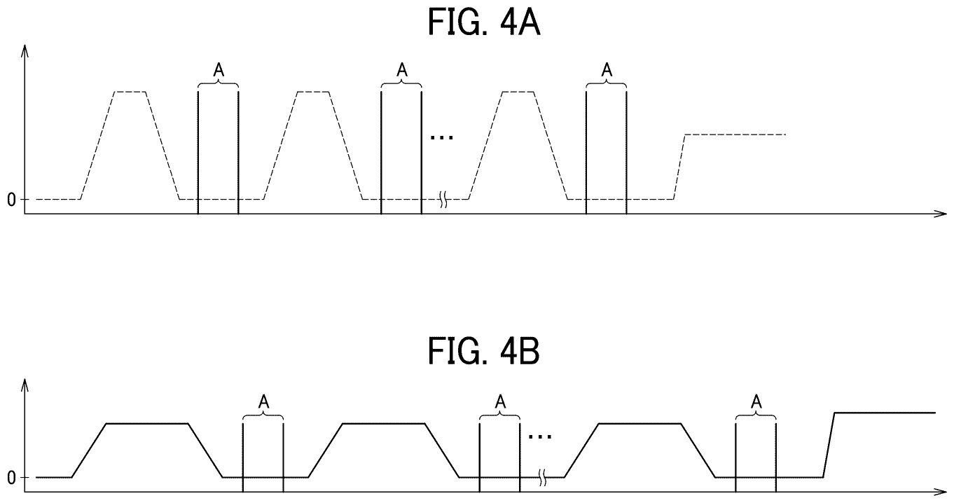

FIG. 4A is a diagram presenting the speed transition of a stage 7 during the white printing and the pre-treatment printing, indicated by the dotted line. FIG. 4B is a diagram presenting the speed transition of the stage 7 during color printing indicated by the solid line. In FIGS. 4A and 4B, the horizontal axis represents time, and the vertical axis represents speed. Range A indicates a time zone in which the carriage 1 reciprocates to perform the liquid discharge operation using the liquid discharge head 6.

As illustrated in FIG. 4A, during the liquid discharge operation in the range A, the stage 7 remains stationary (or stopped) at a predetermined position in the sub-scanning direction, and the liquid is discharged onto a predetermined row in the sub-scanning direction of the fabric by the movement of the carriage 1 in the main scanning direction. When the liquid discharge operation in the row is complete, the stage 7 accelerates again and moves by a predetermined distance in the sub-scanning direction. By repeating this process, each printing operation is completed.

When FIG. 4A and FIG. 4B are compared, the speed and acceleration are set lower during the color printing than during the white printing and the pre-treatment printing. Thus, although the operation time of color printing is longer, the vibration of the stage 7 can be reduced or prevented as described above. Specifically, in the color printing, the time from when the stage 7 starts accelerating to when the stage 7 finishes decelerating is longer than that in the white printing and the pre-treatment printing, and the moving distances in the sub-scanning direction remain the same for all printing operations.

For example, in the present embodiment, the acceleration of the stage 7 during the white printing and pre-treatment printing is set to 490 mm/sec², and the maximum speed is set to 290 mm/sec. The acceleration and maximum speed for the color printing are set to half of these values. However, the ratio of the acceleration and the maximum speed in the color printing to the acceleration and the maximum speed in the white printing and the preprocessing printing is not limited to this. For example, by reducing the acceleration and maximum speed in color printing by 20% or more compared to those in white printing and pre-treatment printing, a certain effect can be achieved in reducing or preventing the vibration of stage 7. The speed and acceleration of the stage 7 can be measured by using, for example, a laser length measuring machine.

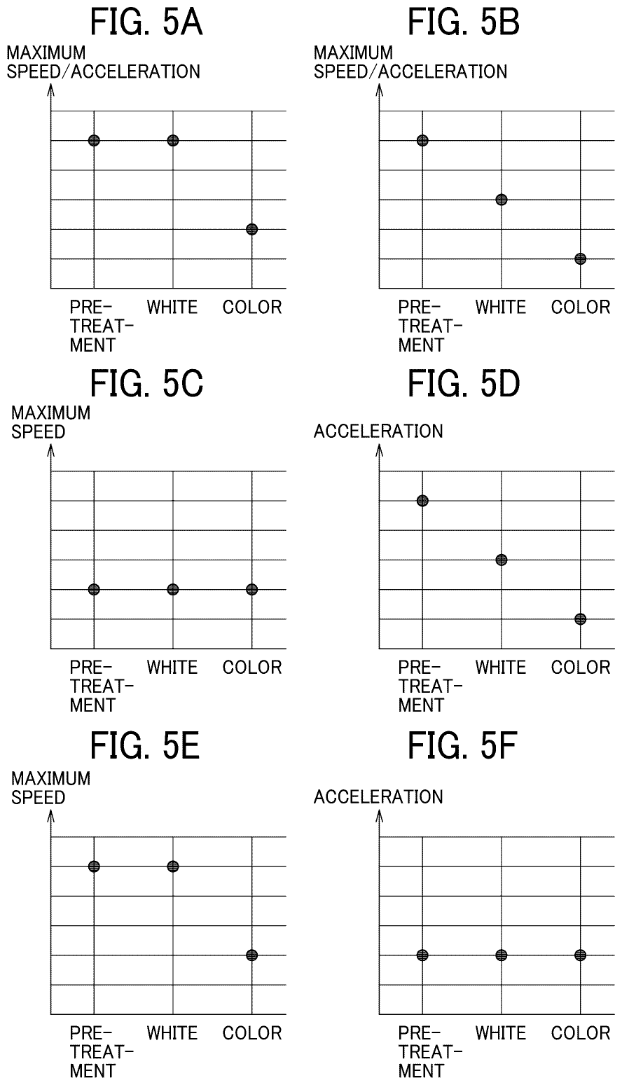

As illustrated in FIG. 5A, in the present embodiment, the acceleration and the maximum speed are set to be the same in the white printing operation and the pretreatment printing operation. By contrast, as illustrated in FIG. 5B, the speed and the acceleration may be set lower in the order of the pre-treatment printing, the white printing, and the color printing. This configuration can reduce or prevents the vibration of the stage 7 and the creation of abnormal images during the white printing where visual defects are more easily identified than during the pre-treatment printing. In some examples, only one of the speed and the acceleration may be changed.

For example, in FIG. 5C, the maximum speed is the same for all the operations, and in FIG. 5D, the acceleration decreases in the order of pre-treatment printing, white printing, and color printing. In FIG. 5E, the maximum speed is the same for white printing and pre-treatment printing, while the maximum speed of color printing is lower than that of white printing and pre-treatment printing. In FIG. 5F, the acceleration is the same for all operations.

FIG. 6 is a block diagram of a hardware configuration of a controller 2000. The controller 2000 includes a central processing unit, a main scanning controller 201, and a sub-scanning controller 202. The main control unit includes the CPU 200 and issues instructions to or commands various control units, such as the main scanning controller 201 and the sub-scanning controller 202. The main scanning controller 201 controls the head 6 to apply liquid (pre-treatment liquid, white ink, and color ink) to the medium. In addition, the main scanning controller 201 determines whether pre-treatment liquid and white printing are to be used, and controls the speed and acceleration of the main scanning carriage 1 during pre-treatment printing, white printing, and color printing. The sub-scanning controller 202 determines whether pre-treatment liquid and white printing are to be used and controls the speed and acceleration of the conveyance member during pre-treatment printing, white printing, and color printing.

The method of acceleration and deceleration is not limited to the above embodiment. For example, the acceleration and deceleration may be performed in a stepwise manner, or the acceleration may be gradually changed.

Note that numerous additional modifications and variations are possible in light of the above teachings. It is therefore to be understood that within the scope of the appended claims, the embodiments of the present disclosure may be practiced otherwise than as specifically described herein. For example, elements and/or features of different illustrative embodiments may be combined with each other and/or substituted for each other within the scope of this disclosure and appended claims.

In the above description, the liquid discharge apparatus including two carriages is described, but the liquid discharge apparatus may include only one carriage or three or more carriages.

In the above embodiments, the fabric is described as an example of the liquid application object, but the liquid application object may be any material onto which liquid can adhere.

The term “liquid discharge apparatus” used herein also represents an apparatus including the carriage including the head to drive the head to discharge a liquid. The term “liquid discharge apparatus” used herein includes, in addition to apparatuses to discharge liquid to a medium onto which liquid can adhere, apparatuses to discharge the liquid into gas (air) or a different liquid.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “material onto which liquid can adhere” represents a material on which liquid is at least temporarily adhered, a material on which liquid is adhered and fixed, or a material into which liquid is adhered to permeate. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of the “material onto which liquid can adhere” include any materials on which liquid can adhere even temporarily, such as paper, thread, fiber, fabric, leather, metal, plastic, glass, wood, and ceramic.

Aspects of the present invention are as follows.

### Aspect 1

A liquid discharge apparatus includes a first head to discharge a first ink; a second head to discharge a second ink different from the first ink; a carriage mounting the first head and the second head to move the first head and the second head in a first scanning direction; a conveyor to move a medium relative to the carriage in a second scanning direction orthogonal to the first scanning direction; and circuitry. The circuitry causes the conveyor to move the medium at least with a first acceleration or at a first speed when the first head discharges the first ink; and causes the conveyor to move the medium at least with a second acceleration different from the first acceleration or at a second speed different from the first speed when the second head discharges the second ink.

### Aspect 2

In the liquid discharge apparatus according to Aspect 1, the first head discharges a color ink as the first ink, and the circuitry is further configured to cause the conveyor to move the medium with the first acceleration lower than the second acceleration when the first head discharges the color ink, and cause the conveyor to move the medium at the first speed lower than the second speed when the first head discharges the color ink.

### Aspect 3

The liquid discharge apparatus according to Aspect 2, further includes a third head to discharge a third ink different from the first ink and the second ink. The second head discharges a white ink as the second ink, and the circuitry causes the conveyor to move the medium with a third acceleration higher than the first acceleration when the third head discharges the third ink; and causes the conveyor to move the medium at the third speed higher than the first acceleration when the third head discharges the third ink.

### Aspect 4

In the liquid discharge apparatus according to Aspect 3, the circuitry causes the conveyor to move the medium with the third acceleration higher than the second acceleration when the third head discharges the third ink; and causes the conveyor to move the medium at the third speed higher than the second speed when the third head discharges the third ink.

### Aspect 5

In the liquid discharge apparatus according to Aspect 3, the circuitry causes the conveyor to move the medium at the third acceleration identical to the second acceleration when the third head discharges the third ink; and causes the conveyor to move the medium at the third speed identical to the second speed when the third head discharges the third ink.

### Aspect 6

The liquid discharge apparatus according to Aspect 3, further includes another carriage mounting the third head to move the third head in the first scanning direction. The carriage moves along a first guide in the first scanning direction, the first guide at a first position in the second scanning direction, and said another carriage moves along a second guide in the first direction, the second guide rod at a second position different from the first position in the second scanning direction.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid discharge apparatus comprising:
a first head to discharge a first ink;
a second head to discharge a second ink different from the first ink;
a carriage mounting the first head and the second head to move the first head and the second head in a first scanning direction;
a conveyor to move a medium relative to the carriage in a second scanning direction orthogonal to the first scanning direction; and
circuitry configured to:
cause the conveyor to move the medium at least with a first acceleration or at a first speed when the first head discharges the first ink; and
cause the conveyor to move the medium at least with a second acceleration different from the first acceleration or at a second speed different from the first speed when the second head discharges the second ink.

2. The liquid discharge apparatus according to claim 1, wherein:
the first head discharges a color ink as the first ink, and
the circuitry is further configured to:
cause the conveyor to move the medium with the first acceleration lower than the second acceleration when the first head discharges the color ink, and
cause the conveyor to move the medium at the first speed lower than the second speed when the first head discharges the color ink.

3. The liquid discharge apparatus according to claim 2, further comprising a third head to discharge a third ink different from the first ink and the second ink, wherein:
the second head discharges a white ink as the second ink, and
the circuitry is further configured to:
cause the conveyor to move the medium with a third acceleration higher than the first acceleration when the third head discharges the third ink; and
cause the conveyor to move the medium at the third speed higher than the first acceleration when the third head discharges the third ink.

4. The liquid discharge apparatus according to claim 3, wherein:
the circuitry is further configured to:
cause the conveyor to move the medium with the third acceleration higher than the second acceleration when the third head discharges the third ink; and
cause the conveyor to move the medium at the third speed higher than the second speed when the third head discharges the third ink.

5. The liquid discharge apparatus according to claim 3, wherein:
the circuitry is further configured to:
cause the conveyor to move the medium at the third acceleration identical to the second acceleration when the third head discharges the third ink; and
cause the conveyor to move the medium at the third speed identical to the second speed when the third head discharges the third ink.

6. The liquid discharge apparatus according to claim 3, further comprising:
another carriage mounting the third head to move the third head in the first scanning direction,
wherein the carriage moves along a first guide in the first scanning direction, the first guide at a first position in the second scanning direction, and
said another carriage moves along a second guide in the first direction, the second guide rod at a second position different from the first position in the second scanning direction.
